(19) United States
(12) Patent Application Publication
(10) Pub. No.: US 2020/0137153 A1
(43) Pub. Date: Apr. 30, 2020

(54) METHOD FOR ESTABLISHING PEER TO PEER SERVICE SESSION OVER INFRASTRUCTURE LINK

(71) Applicant: Samsung Electronics Co., Ltd., Gyeonggi-do (KR)

(72) Inventors: Mayuresh Madhukar Patil, Bangalore (IN); Byung Moo Lee, Gyeonggi-do (KR); Chang Soon Kim, Gyeonggi-do (KR); Jong Mu Choi, Gyeonggi-do (KR); Joo Yeol Lee, Gyeonggi-do (KR); Soo Yong Lee, Gyeonggi-do (KR)

(73) Assignee: Samsung Electronics Co., Ltd.

(21) Appl. No.: 16/700,767

(22) Filed: Dec. 2, 2019

Related U.S. Application Data
(63) Continuation of application No. PCT/KR2018/012745, filed on Oct. 25, 2018.

(51) Int. Cl. H04L 29/08; H04W 76/14; H04W 8/00; H04W 80/04; H04W 48/16; H04W 48/18

(52) U.S. Cl. CPC H04L 67/1061; H04W 76/14; H04L 67/16; H04W 48/18; H04W 80/04; H04W 48/16; H04W 8/005

(57) ABSTRACT

Disclosed is a method for establishing a peer to peer (P2P) service session over an infrastructure link. The method includes sending, by a source device, an infrastructure discovery request message to discover a wireless service to a sink device. Further, the method includes receiving, by the source device, an infrastructure discovery response message from the sink device. Further, the method includes sending, by the source device, a connection capability exchange request message to discover the wireless service to the sink device. Further, the method includes receiving, by the source device, a connection capability exchange response message including a plurality of P2P connection configuration parameters from the sink device. Furthermore, the method includes establishing, by the source device, the P2P service session with the sink device based on the plurality of P2P connection configuration parameters.

### PRIORITY

This application is continuation of International Application No. PCT/KR2018/012745 filed on Oct. 25, 2018, the contents of which are incorporated herein by reference.

### BACKGROUND

### 1. Field

The present application relates to a communication system, and more particularly to a mechanism for establishing a peer to peer (P2P) service session over an infrastructure link.

### 2. Description of the Related Art

As an electronic device and a wireless communication technique continue to improve and grow in popularity, a short-range wireless communication technique is expected to supplant or replace a need for connecting the electronic devices together using a cable, a wire or the like. As part of this evolution, a number of new techniques (e.g., miracast technique, or the like) are beginning to emerge that allow high-speed unidirectional wireless communication between the electronic devices. The use of these emerging techniques in unconventional ways to provide users of the electronic devices with access to new and improved communication services, functionalities, and capabilities will be beneficial to the user of the electronic devices.

Currently, the mechanism for communicating information over a miracast infrastructure includes negotiating a wireless communication link over the miracast infrastructure between the electronic devices (i.e., source device and sink device), and establishing a miracast session between the electronic devices through the wireless communication link. The mechanism for establishing the miracast session utilizes a Peer to Peer (P2P) technique for a discovery and connection, which requires more time for the connection. When the electronic devices are connected to the infrastructure link, then the miracast session over an infrastructure link gives more delay in a mirroring application. The mirroring application utilizing a Tunneled Direct Link Setup (TDLS) can speed up the connection procedure, but the TDLS has issues in terms of stability, it is not a stable mechanism and use of the TDLS results problem of disconnection of the infrastructure connections.

Thus, it is desired to address the above mentioned disadvantages or other shortcomings or at least provide a useful alternative.

### SUMMARY

An object of the embodiments herein is to provide a method for establishing a peer to peer (P2P) service session over an infrastructure link.

Another object of the embodiments herein is to provide a mechanism for sending, by a source device, an infrastructure discovery request message to discover a wireless service to a sink device.

Another object of the embodiments herein is to provide a mechanism for receiving, by a source device, an infrastructure discovery response message from a sink device.

Another object of the embodiments herein is to provide a mechanism for sending, by a source device, a connection capability exchange request message to discover a wireless service to a sink device.

Another object of the embodiments herein is to provide a mechanism for receiving, by a source device, a connection capability exchange response message including a plurality of P2P connection configuration parameters from a sink device.

Another object of the embodiments herein is to provide a mechanism for receiving, by a sink device, an infrastructure discovery request message to discover a wireless service from a source device.

Another object of the embodiments herein is to provide a mechanism for sending, by a sink device, an infrastructure discovery response message to a source device.

Another object of the embodiments herein is to provide a mechanism for receiving, by a sink device, a connection capability exchange request message to discover a wireless service from a source device.

Another object of the embodiments herein is to provide a mechanism for sending, by a sink device, a connection capability exchange response message including a plurality of P2P connection configuration parameters to a source device.

Embodiments herein disclose a method for establishing a peer to peer (P2P) service session over an infrastructure link. The method includes sending, by a source device, an infrastructure discovery request message to discover a wireless service to a sink device. Further, the method includes receiving, by the source device, an infrastructure discovery response message from the sink device. Further, the method includes sending, by the source device, a connection capability exchange request message to discover the wireless service to the sink device. Further, the method includes receiving, by the source device, a connection capability exchange response message including a plurality of P2P connection configuration parameters from the sink device. Furthermore, the method includes establishing, by the source device, the P2P service session with the sink device based on the plurality of P2P connection configuration parameters.

Embodiments herein disclose a method for establishing a peer to peer (P2P) service session over an infrastructure link. The method includes receiving, by a sink device, an infrastructure discovery request message to discover a wireless service from a source device. Further, the method includes sending, by the sink device, an infrastructure discovery response message to the source device. Further, the method includes receiving, by the sink device, a connection capability exchange request message to discover the wireless service from the source device. Further, the method includes sending, by the sink device, a connection capability exchange response message including a plurality of P2P connection configuration parameters to the source device. Furthermore, the method includes establishing, by the sink device, the P2P service session with the source device based on the plurality of P2P connection configuration parameters.

Embodiments herein disclose a source device for establishing a peer to peer (P2P) service session with a sink device over an infrastructure link. The source device is configured to send an infrastructure discovery request message to discover a wireless service to a sink device. Further, the source device is configured to receive an infrastructure discovery response message from the sink device. Further, the source device is configured to send a connection capability exchange request message to discover the wireless service to the sink device. Further, the source device is configured to receive a connection capability exchange response message including a plurality of P2P connection configuration parameters from the sink device. Furthermore, the source device is configured to establish the P2P service session with the sink device based on the plurality of P2P connection configuration parameters.

Embodiments herein disclose a sink device for establishing a peer to peer (P2P) service session with a source device over an infrastructure link. The sink device is configured to receive an infrastructure discovery request message to discover a wireless service from a source device. Further, the sink device is configured to send an infrastructure discovery response message to the source device. Further, the sink device is configured to receive a connection capability exchange request message to discover the wireless service from the source device. Further, the sink device is configured to send a connection capability exchange response message including a plurality of P2P connection configuration parameters to the source device. Furthermore, the sink device is configured to establish the P2P service session with the source device based on the plurality of P2P connection configuration parameters.

Embodiments herein provide a computer program product including a computer executable program code recorded on a computer readable non-transitory storage medium. The computer executable program code provides when executed causing the actions including sending, by a source device, an infrastructure discovery request message to discover a wireless service to a sink device. The computer executable program code provides, when executed causing the actions including receiving, by the source device, an infrastructure discovery response message from the sink device. The computer executable program code provides when executed causing the actions including sending, by the source device, a connection capability exchange request message to discover the wireless service to the sink device. The computer executable program code provides when executed causing the actions including receiving, by the source device, a connection capability exchange response message including a plurality of peer to peer (P2P) connection configuration parameters from the sink device. The computer executable program code provides when executed causing the actions including establishing, by the source device, a P2P service session with the sink device based on the plurality of P2P connection configuration parameters.

Embodiments herein provide a computer program product including a computer executable program code recorded on a computer readable non-transitory storage medium. The computer executable program code provides when executed causing the actions including receiving, by a sink device, an infrastructure discovery request message to discover a wireless service from a source device. The computer executable program code provides when executed causing the actions including sending, by the sink device, an infrastructure discovery response message to the source device. The computer executable program code provides when executed causing the actions including receiving, by the sink device, a connection capability exchange request message to discover the wireless service from the source device. The computer executable program code provides when executed causing the actions including sending, by the sink device, a connection capability exchange response message comprising a plurality of Peer to Peer (P2P) connection configuration parameters to the source device. The computer executable program code provides when executed causing the actions including establishing, by the sink device, a P2P service session with the source device based on the plurality of P2P service configuration parameters.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1 is a sequence flow diagram illustrating various operations performed to establish a peer to peer (P2P) service session over an infrastructure link, according to an embodiment as disclosed herein;

FIG. 2 illustrates various units of a source device or a sink device, according to embodiments as disclosed herein;

FIG. 3 is a sequence flow diagram illustrating various operations performed to establish a P2P service session over an infrastructure link using a Real Time Streaming Protocol (RTSP) parameter, according to an embodiment as disclosed herein;

FIG. 4 is a sequence flow diagram illustrating various operations performed to establish a P2P service session over an infrastructure link using an Application Service Platform (ASP) parameter, according to an embodiment as disclosed herein;

FIG. 5 is a flow diagram illustrating a method for establishing a P2P service session over an infrastructure link by a source device, according to an embodiment as disclosed herein;

FIG. 6 is a flow diagram illustrating a method for establishing a P2P service session over an infrastructure link by a sink device, according to an embodiment as disclosed herein; and

FIG. 7 illustrates a computing environment implementing a mechanism for establishing a P2P service session over an infrastructure link, according to an embodiment as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Throughout the description, the term connection capability exchange request message is used to exchange connection capability related information between a source device and a sink device or non-exclusively related to a message which carries fields for connection capability information to discover a wireless service between the source device and the sink device.

Throughout the description, the term connection capability exchange response message is used to exchange connection capability related information between the source device and the sink device. In some embodiments, the term connection capability exchange response message non-exclusively refers to any message which carries connection capability information.

The embodiments herein provide a method for establishing a peer to peer (P2P) service session over an infrastructure link. The method includes sending, by a source device, an infrastructure discovery request message to discover a wireless service to a sink device. Further, the method includes receiving, by the source device, an infrastructure discovery response message from the sink device. Further, the method includes sending, by the source device, a connection capability exchange request message to discover the wireless service to the sink device. Further, the method includes receiving, by the source device, a connection capability exchange response message including a plurality of P2P connection configuration parameters from the sink device. Furthermore, the method includes establishing, by the source device, the P2P service session with the sink device based on the plurality of P2P connection configuration parameters.

In an embodiment, the P2P connection configuration parameter includes at least one of a P2P device address, AutoGo group information, a group identifier, operating channel information, a device role, an Internet Protocol (IP) address of the sink device, an IP address of the source device, a connection preference and a connection capability bitmap.

In an embodiment, the connection capability bitmap indicates support interfaces by the source device and the sink device.

The aim of the connection capability exchange between an Application Service Platform (ASP) on the sink device (i.e., service seeker) and an ASP on the source device (i.e., service advertiser) is to enable early assessment of connection feasibility and connection topology for efficient reuse or creation of P2P groups. By sharing connection capabilities after a discovery procedure, the technique establishes the P2P service session over the infrastructure link by sending a provision discovery request frame that includes the information in its connection capability information attribute.

In an embodiment, the connection capability information can be included in the infrastructure discovery exchange information.

In an embodiment, the infrastructure discovery exchange information includes a Connection Capability Exchange (CCEX) information attribute. The format of the CCEX Information attribute is shown in following Table 1.

TABLE 1

| | Size | | |
|---|---|---|---|
| Field Name | (octets) | Value | Description |
| Attribute ID | 1 | 29 | Identifying the type of P2P attribute. |
| | | | The specific value is defined in P2P |
| | | | Attribute ID definitions. |
| Length | 2 | 1 | Length of the following fields in the |
| | | | attribute. |
| CCEX | 1 | variable | Bit 0: P2P Connection. Bit 0 set to 1 |
| Information | | | indicates that P2P connection is |
| | | | supported. Otherwise, not supported. |
| | | | Bit 1: Infrastructure Connection. Bit 1 |
| | | | set to 1 indicates that Infrastructure |
| | | | connection is supported. Otherwise, not |
| | | | supported. |
| | | | Bit 2-7: Reserved. |

In an embodiment, the infrastructure discovery request message and the infrastructure discovery response message are carried over one of a Bonjour protocol, a Universal Plug and Play (UPnP) protocol, IP packets using a User Datagram Protocol (UDP), and IP packets using a Transfer Control Protocol (TCP).

The embodiments herein provide a method for establishing P2P service session over an infrastructure link. The method includes receiving, by a sink device, an infrastructure discovery request message to discover a wireless service from a source device. Further, the method includes sending, by the sink device, an infrastructure discovery response message to the source device. Further, the method includes receiving, by the sink device, a connection capability exchange request message to discover the wireless service from the source device. Further, the method includes sending, by the sink device, a connection capability exchange response message including a plurality of P2P connection configuration parameters to the source device. Furthermore, the method includes establishing, by the sink device, the P2P service session with the source device based on the plurality of P2P connection configuration parameters.

In an embodiment, the connection capability information can be included in the corresponding infrastructure discovery messages in case of the Bonjour protocol this will be included in text (TXT) records.

The TXT records include a preferred connection, Basic Service Set Identification (BSSID) (associated), additional Tunneled Direct Link Setup (TDLS) parameters (e.g. supported channel, rates, link identifier, or the like) and P2P parameter. The TXT records contain attributes. In an example, mandatory attributes parameters in the TXT records are: preferconn=tdls/p2p and BSSID=12 bytes (Media Access Control (MAC) of an Access Point (AP)). In an example, optional attributes parameters in the TXT records are: TDLS parameters (e.g., channelSwitch, channellist, rates, or the like).

For examples of txt records are: /019preferconn=td1s/022bssid=08002700F06D, /019preferconn=td1s/022bssid=08002700F06D (additional TDLS parameters).

Unlike conventional systems and methods, the proposed method can be used to provide a faster miracast setup and allow the sink device and the source device to be directly stream a media content (e.g., video, multimedia, or the like) using a P2Pchannel. The method can be used to utilize the infrastructure connection to negotiate the miracast setup. The method can be used to provide a direct connection to establish the P2P service session over the infrastructure link in a fast manner.

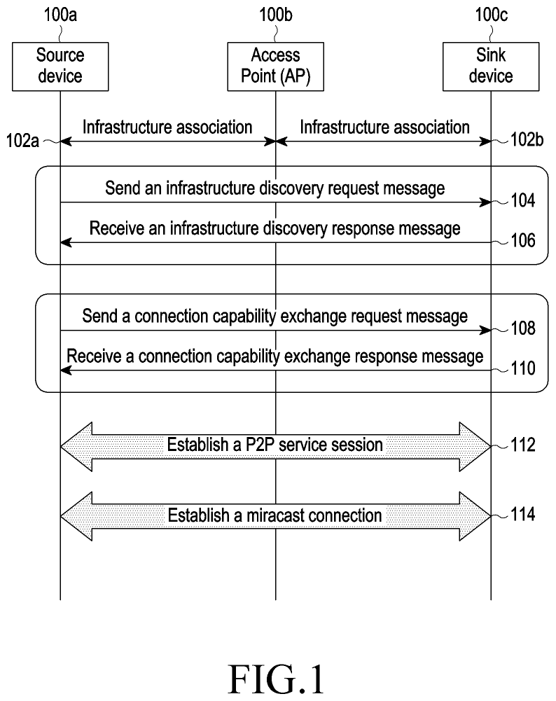

Referring now to the drawings and more particularly to FIGS. 1 through 7, where similar reference characters denote corresponding features consistently throughout the drawings, there are shown preferred embodiments.

FIG. 1 is a sequence flow diagram illustrating various operations performed to establish a P2P service session over an infrastructure link, according to an embodiment as disclosed herein. The P2P service session can be, for example but not limited to a miracast session (i.e., peer-to-peer wireless screen cast session), or the like. Initially, the source device 100a and the sink device 100c perform (102a and 102b) an infrastructure association procedure over an AP 100b (e.g. Wireless-Fidelity (Wi-Fi) Direct, or the like). The source device 100a can be, for example but not limited to, a television (TV), a smartphone, a cellular telephone, a mobile multi-media player, a Personal Data Assistant (PDA), a watch, a wrist display, a tablet computer, a laptop computer, a netbook, a palm-top computer, a wireless electronic mail receiver, a camera, a multimedia Internet enabled cellular telephone, a wireless gaming controller, and other similar electronic devices that include a programmable processor and circuitry for wirelessly sending and receiving information. The sink device 100c can be, for example but not limited to, the TV, the smartphone, the cellular telephone, the mobile multi-media player, the PDA, the watch, the wrist display, the tablet computer, the laptop computer, the projector, the netbook, the palm-top computer, the wireless electronic mail receiver, the multimedia Internet enabled cellular telephone, the wireless gaming controller, and other similar electronic devices that include a programmable processor and circuitry for wirelessly sending and receiving information.

After performing the infrastructure association, the source device 100a sends (104) an infrastructure discovery request message to discover a wireless service to the sink device 100c.

In an embodiment, the infrastructure discovery request message is carried over a Bonjour protocol.

In an embodiment, the infrastructure discovery request message is carried over a Universal Plug and Play (UPnP) protocol.

In an embodiment, the infrastructure discovery request message is carried over an IP packet using a User Datagram Protocol (UDP).

In an embodiment, the infrastructure discovery request message is carried over the IP packets using a Transfer Control Protocol (TCP).

Based on sending the infrastructure discovery request message, the source device 100a receives (106) the infrastructure discovery response message from the sink device 100c.

In an embodiment, the infrastructure discovery response message is carried over the Bonjour protocol.

In an embodiment, the infrastructure discovery response message is carried over the UPnP protocol.

In an embodiment, the infrastructure discovery response message is carried over the IP packets using the UDP.

In an embodiment, the infrastructure discovery response message is carried over the IP packets using the TCP.

After receiving the infrastructure discovery response message from the sink device 100c, the source device 100a sends (108) a connection capability exchange request message or a message which carries fields for connection capability information to discover the wireless service to the sink device 100c. Based on sending the connection capability exchange request message or message which carries the fields for connection capability information to discover the wireless service to the sink device 100c, the source device 100a receives (110) the connection capability exchange response message including a plurality of P2P connection configuration parameters from the sink device 100c.

The P2P connection configuration parameter can be, for example but not limited to a P2P device address, an AutoGo group information, a group identifier, an operating channel information, a device role, an Internet Protocol (IP) address of the sink device 100c, an IP address of the source device 100a, connection preference, and a connection capability bitmap.

In an embodiment, the connection capability bitmap indicates the support interfaces.

The aim of the connection capability exchange between an Application Service Platform (ASP) on the sink device (i.e., service seeker) and the ASP on the source device (i.e., service advertiser) is to enable early assessment of connection feasibility and connection topology for efficient reuse or creation of the P2P groups. By sharing connection capabilities after the discovery procedure, the technique establishes the P2P service session over the infrastructure link by sending a provision discovery request frame that includes the information in its connection capability Info attribute.

In an embodiment, the connection capability information can be included in the infrastructure discovery exchanges information.

Based on the connection capability exchange response message, the source device 100a establishes (112) the P2P service session with the sink device 110c. After establishing the P2P service session, the miracast connection 114 is established (114) between the sink device 100c and the source device 100a.

In an example, consider that the source device 100a start the discovery process and discover for the miracast service and also possibly search the sink device 100c. Once the sink device 100c is discovered, a discovery information exchanges the necessary information require to exchanges further connection capabilities. This is called as the connection capability exchanges. The connection capability exchange will include the P2P connection information. The connection capability exchanges between the source device 100a and the sink device 100c which will exchange the P2P connection information and negotiation information.

Once negotiations are completed, the source device 100a and the sink device 100c both with start the P2P connection and start streaming over the P2P. Thus results in speeding up the service negotiation and discovery, since the method utilizes an existing connection (i.e., infrastructure connection) for discovery which will be faster than a P2P interface.

The method can be used to provide the faster miracast setup and allow the sink device 100c and the source device 100a to be directly stream the media content (e.g., video, multimedia, or the like) using the P2P link. The method can be used to utilize the infrastructure connection to negotiate the miracast setup. The method can be used to provide the direct connection to establish the P2P service session over the infrastructure link in a fast manner.

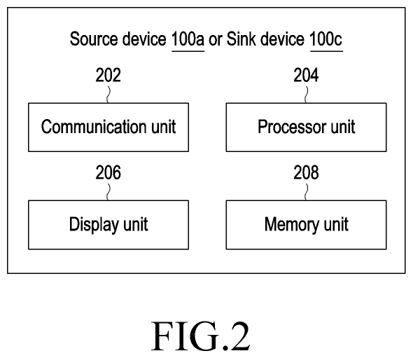

FIG. 2 illustrates various units of the source device 100a or the sink device 100c, according to embodiments as disclosed herein. In an embodiment, the source device 100a or the sink device 100c includes a communication unit 202, a processor unit 204, a display unit 206, and a memory unit 208. The communication unit 202 is configured to send the infrastructure discovery request message to discover the wireless service to the sink device 100c. Based on sending the infrastructure discovery request message to discover the wireless service to the sink device 100c, the communication unit 202 is configured to receive the infrastructure discovery response message from the sink device 100c.

In an embodiment, the infrastructure discovery request message and the infrastructure discovery response message are carried over the Bonjour protocol.

In an embodiment, the infrastructure discovery request message and the infrastructure discovery response message are carried over the UPnP protocol.

In an embodiment, the infrastructure discovery request message and the infrastructure discovery response message are carried over the IP packets using the UDP.

In an embodiment, the infrastructure discovery request message and the infrastructure discovery response message are carried over the IP packets using the TCP.

After receiving the infrastructure discovery response message from the sink device 100c, the communication unit 202 is configured to send the connection capability exchange request message or the message which carries the fields for connection capability information to discover the wireless service to the sink device 100c. Based on sending the connection capability exchange request message or the message which carries the fields for connection capability information to discover the wireless service to the sink device 100c, the communication unit 202 is configured to receive the connection capability exchange response message or the response to the request which carries connection capability information including the plurality of P2P connection configuration parameters from the sink device 100c.

In an embodiment, the connection capability information can be included in the infrastructure discovery exchanges information.

After receiving the connection capability exchange response message or the response to the request which carries the connection capability information, the processor unit 204 is configured to establish the P2P service session with the sink device 100c based on the plurality of P2P connection configuration parameters.

In an embodiment, the communication unit 202 is configured to receive the infrastructure discovery request message to discover the wireless service from the source device 100a. After receiving the infrastructure discovery request message, the communication unit 202 is configured to send the infrastructure discovery response message to the source device 100a. Based on sending the infrastructure discovery response message to the source device 100a, the communication unit 202 is configured to receive the connection capability exchange request message to discover the wireless service from the source device 100a. After receiving the connection capability exchange request message, the communication unit 202 is configured to send the connection capability exchange response message including the plurality of P2P connection configuration parameters to the source device 100a. Based on sending the connection capability exchange response message to the source device 100a, the processor unit 204 is configured to establish the P2P service session with the source device 100a based on the plurality of P2P connection configuration parameters.

Further, the communication unit 202 is configured for communicating internally between internal units and with external devices via one or more networks. The processor unit 204 is provided with the display unit 206. The memory unit 208 may include one or more computer-readable storage media. The memory unit 208 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the memory unit 208 may, in some examples, be considered a non-transitory storage medium. The term “non-transitory” may indicate that the storage medium is not embodied in a carrier wave or a propagated signal. However, the term “non-transitory” should not be interpreted that the memory unit 208 is non-movable. In some examples, the memory unit 208 can be configured to, store larger amounts of information. In certain examples, a non-transitory storage medium may store data that can, over time, change (e.g., in Random Access Memory (RAM) or cache).

Although FIG. 2 shows exemplary units of the source device 100a or the sink device 100c but it is to be understood that other embodiments are not limited thereon. In other embodiments, the source device 100a or the sink device 100c may include fewer or more units. Further, the labels or names of the units are used only for illustrative purpose and does not limit the scope of the invention. One or more units can be combined together to perform same or substantially similar function to establish the P2P service session over the infrastructure link.

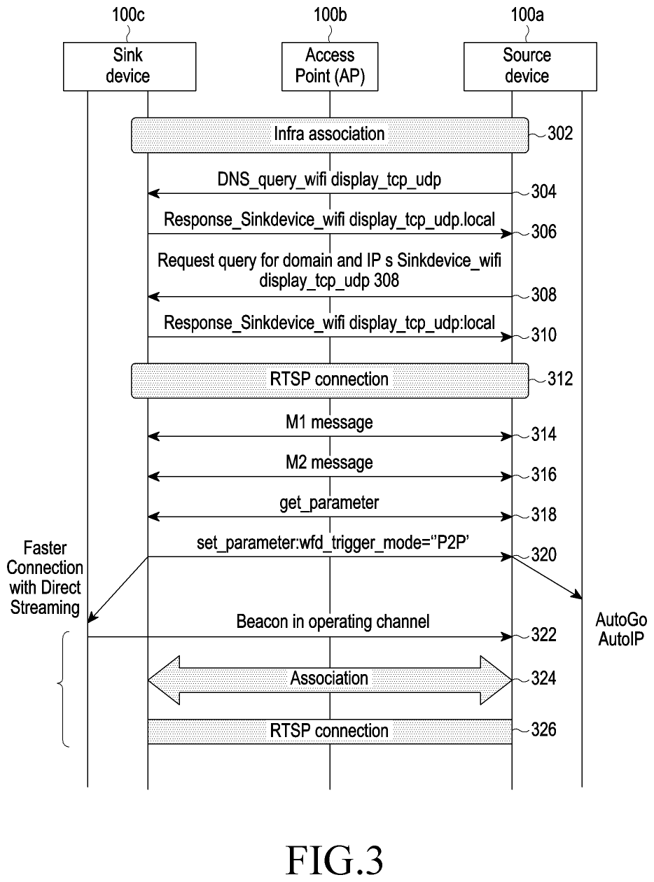

FIG. 3 is a sequence flow diagram illustrating various operations performed to establish the P2P service session over the infrastructure link using a Real Time Streaming Protocol (RTSP) parameter, according to an embodiment as disclosed herein. Initially, the source device 100a and the sink device 100c perform (302) the infrastructure association procedure using one of the bonjour protocol and the UPnP protocol. After performing the infrastructure association procedure, the source device 100a sends (304) a DNS_query_wifi display_tcp_udp message to the sink device 100c. Based on receiving the DNS_query_wifi display_tcp_udp message in the sink device 100c, the sink device 100c sends (306) a sinkdevice_wifi display_tcp_udp.local response message to the source device 100a. Based on receiving the sinkdevice_wifi display_tcp_udp.local response message in the source device 100a, the source device sends (308) a request query for a domain and IPs sinkdevice_wifi display_tcp_udp to the sink device 100c. Based on receiving the request query for the domain and IPs sinkdevice_wifi display_tcp_udp to the sink device 100c, the sink device 100c sends (310) the response_sinkdevice_wifi display_tcp_udp: local message to the source device 100a. In an embodiment, the sink device 100c sends a Miracast.sink message, an org.wifi.display.sink message, or other type message including the sink capability to the source device 100a. Based on the response_sinkdevice_wifi display_tcp_udp: local message, a RTSP connection is established (312) between the source device 100a and the sink device 100c. Based on the RTSP connection, a M1 message is exchanged (314) between the source device 100a and the sink device 100c. Based on the M1 message, a M2 message is exchanged (316) between the source device 100a and the sink device 100c. Based on the M2 message, the get_parameter is exchanged (318) between the source device 100a and the sink device 100c using a M3 message. The get_parameter can be, for example but not limited to, the P2P device address, the AutoGo group information, the group identifier, the operating channel information, the device role, the IP address of the sink device 100c, the IP address of the source device 100a, the connection capability bitmap, or the like. Based on the get_parameter, the set_parameter is exchanged (320) between the source device 100a and the sink device 100c. The set_parameter can be a Wfd_Trigger_method: “P2P”, or the like.

Based on the set_parameter, the source device 100a and the sink device 100c terminate the RTSP connection, the sink device 100c triggers an AutoGo procedure and an AutolP procedure to set an operating channel, and the source device 100a joins a P2P group. The source device 100a and the sink device 100c start the P2P connection using the AutoGo procedure and the AutoIP procedure. The sink device 100c sends (322) a beacon signal to the source device 100c over the operating channel. A RTSP connection association procedure is performed (324) between the source device 100a and the sink device 100c. The source device 100a and the sink device 100c directly start (326) the RTSP connection and establish the P2P service session as the IP address assignment is already done (received in the get_parameter) and the sink device 100c send a M5 message directly to trigger the setup the RTSP connection.

In an embodiment, the get_parameter also includes a static IP address of the sink device 100c which will allow direct connection and fast IP address assignment.

In an example, the method allows the user to wirelessly transmit the video content from the source device 100a (e.g., smartphone, tablet, or the like) to the sink device 100c (e.g., TV) utilizing the existing infrastructure connection. This results in speeding up the video service negotiation and discovery procedure in the miracast service.

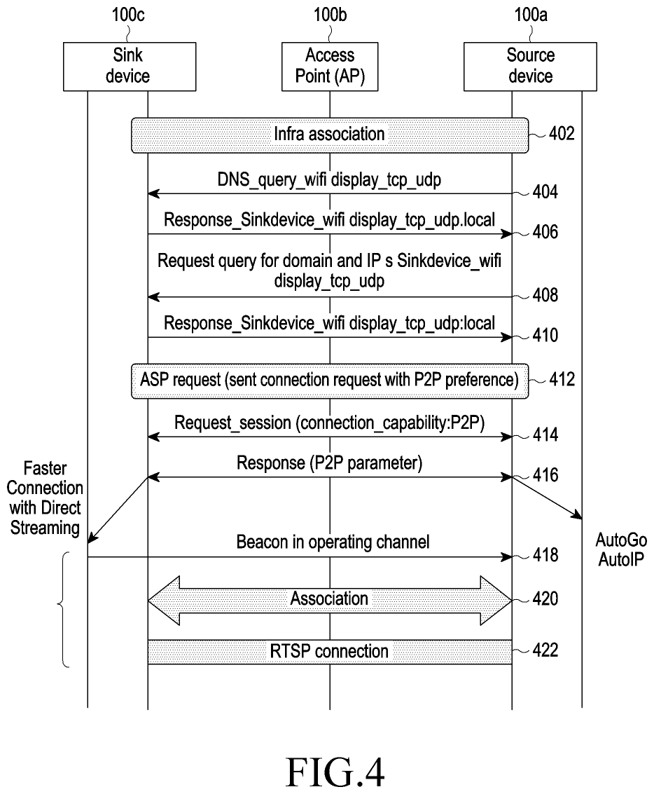

FIG. 4 is a sequence flow diagram illustrating various operations performed to establish the P2P service session over the infrastructure link using an Application Service Platform (ASP) parameter, according to an embodiment as disclosed herein. Initially, the source device 100a and the sink device 100c perform (402) the infrastructure association procedure. The infrastructure association procedure is carried over one of the Bonjour protocol, the UPnP protocol, the IP packets using UDP, the IP packets using TCP, or the like. After performing the infrastructure association procedure, the source device 100a sends (404) the DNS_query_wifi display_tcp_udp message to the sink device 100c. Based on receiving the DNS_query_wifi display_tcp_udp message in the sink device 100c, the sink device 100c sends (406) a sink device wife display_tcp_udp.local response message to the source device 100a. Based on receiving the sinkdevice_wifi display_tcp_udp.local response message in the source device 100a, the source device sends (408) a request query for a domain and IPs sinkdevice_wifi display_tcp_udp to the sink device 100c. Based on receiving the request query for the domain and IPs sinkdevice_wifi display_tcp_udp to the sink device 100c, the sink device 100c sends (410) the response_sinkdevice_wifi display_tcp_udp: local message to the source device 100a. Based on the response_sinkdevice_wifi display_tcp_udp: local message, an ASP connection request along with the P2P preference is exchanged (412) between the source device 100a and the sink device 100c. Based on the ASP connection request along with the P2P preference, the source device 100a sends (414) a request_session message (i.e., connection capability along with the P2P preference). Based on the request_session message, the sink device 100c sends (416) the response message (i.e., P2P parameter information message) to the source device 100a. Based on the response message, the sink device 100c sends (418) the beacon signal to the source device 100c over the operating channel. Based on the beacon signal, the RTSP connection association procedure is performed (420) between the source device 100a and the sink device 100c. Based on the RTSP connection association procedure, the RTSP connection is established between the source device 100a and the sink device 100c.

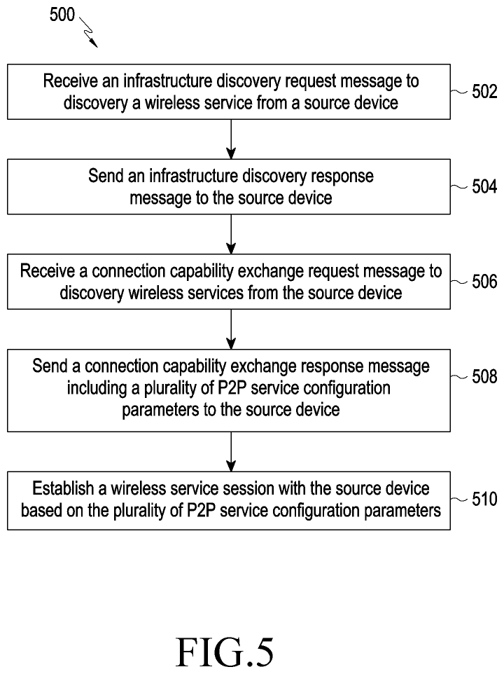

FIG. 5 is a flow diagram illustrating a method 500 for establishing the P2P service session over the infrastructure link by the source device 100a, according to an embodiment as disclosed herein. At step 502, the method 500 includes sending the infrastructure discovery request message to discover the wireless service to the sink device 100c. In an embodiment, the method 500 allows the communication unit 202 to send the infrastructure discovery request message to discover the wireless service to the sink device 100c. At step 504, the method 500 includes receiving the infrastructure discovery response message from the sink device 100c. In an embodiment, the method 500 allows the communication unit 202 to receive the infrastructure discovery response message from the sink device 100c. At step 506, the method 500 includes sending the connection capability exchange request message or the message which carries the fields for the connection capability information to discover the wireless service to the sink device 100c. In an embodiment, the method 500 allows the communication unit 202 to send the connection capability exchange request message or the message which carries the fields for the connection capability information to discover the wireless service to the sink device 100c.

At step 508, the method 500 includes receiving the connection capability exchange response message or the response to the request which carries the connection capability information including the plurality of P2P connection configuration parameters from the sink device. In an embodiment, the method 500 allows the communication unit 202 to receive the connection capability exchange response message including the plurality of P2P connection configuration parameters from the sink device 100c.

In an embodiment, the connection capability information can be included in the infrastructure discovery exchanges information.

At step 510, the method 500 includes establishing the P2P service session with the sink device 100c based on the plurality of P2P connection configuration parameters. In an embodiment, the method 500 allows the processor unit 204 to establish the P2P service session with the sink device 100c based on the plurality of P2P connection configuration parameters.

In an example, consider, the source device 100a will start the discovery process and discover for the miracast service and also possibly search the sink device 100c. Once the sink device 100c is discovered, the discovery information exchanges the necessary information require to exchanges further connection capabilities. This is called as the connection capability exchange information. The connection capability exchange information will include the P2P connection information. The connection capability exchanges between the source device 100a and the sink device 100c which will exchange the P2P connection information and negotiation.

Once negotiations are completed, the source device 100a and the sink device 100c both with start the P2P connection and start streaming over the P2P. Thus results in speeding up the service negotiation and discovery, since the method 500 utilizes an existing connection (i.e., existing infrastructure connection) for discovery which will be faster than the P2P interface.

The various actions, acts, blocks, steps, or the like in the method 500 may be performed in the order presented, in a different order or simultaneously. Further, in some embodiments, some of the actions, acts, blocks, steps, or the like may be omitted, added, modified, skipped, or the like without departing from the scope of the invention.

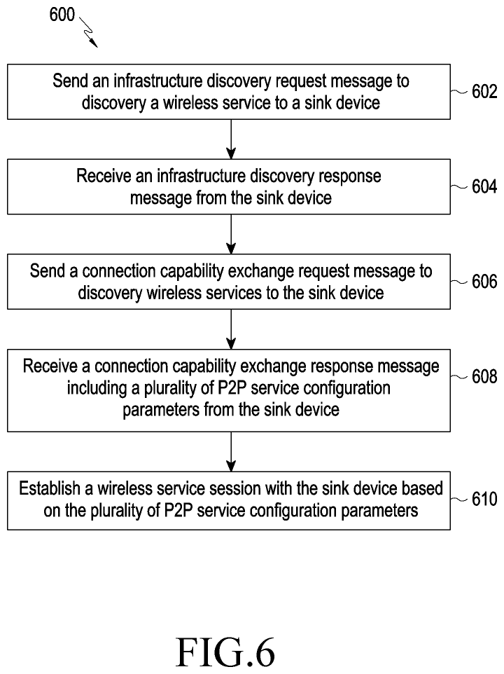

FIG. 6 is a flow diagram illustrating a method 600 for establishing the P2P service session over the infrastructure link by the sink device 100c, according to an embodiment as disclosed herein. At step 602, the method 600 includes receiving the infrastructure discovery request message to discover the wireless service from the source device 100a. In an embodiment, the method 600 allows the communication unit 202 to receive the infrastructure discovery request message to discover the wireless service from the source device 100a. At step 604, the method 600 includes sending the infrastructure discovery response message to the source device 100a. In an embodiment, the method 600 allows the communication unit 202 to send the infrastructure discovery response message to the source device 100a. At step 606, the method 600 includes receiving the connection capability exchange request message to discover the wireless service from the source device 100a. In an embodiment, the method 600 allows the communication unit 202 to receive the connection capability exchange request message to discover the wireless service from the source device 100a.

In an embodiment, the connection capability information can be included in the infrastructure discovery exchanges information.

At step 608, the method 600 includes sending the connection capability exchange response message including the plurality of P2P connection configuration parameters to the source device 100a. In an embodiment, the method 600 allows the communication unit 202 to send the connection capability exchange response message including the plurality of P2P connection configuration parameters to the source device 100a. At step 610, the method 600 includes establishing the P2P service session with the source device 100a based on the plurality of P2P connection configuration parameters. In an embodiment, the method 600 allows the processor unit 204 to establish the P2P service session with the source device 100a based on the plurality of P2P connection configuration parameters.

The method 600 can be used to provide the faster miracast setup and allow the sink device 100a and the source device 100c to be directly stream the media content (e.g., video, multimedia, or the like) using the P2P link. The method 600 can be used to utilize the infrastructure connection to negotiate the miracast setup. The method 600 can be used to provide the direct connection to establish the P2P service session over the infrastructure link in fast manner.

The various actions, acts, blocks, steps, or the like in the method 600 may be performed in the order presented, in a different order or simultaneously. Further, in some embodiments, some of the actions, acts, blocks, steps, or the like may be omitted, added, modified, skipped, or the like without departing from the scope of the invention.

In an embodiment, the connection capability information can be included in the corresponding infrastructure discovery messages in case of the Bonjour protocol this will be included in the TXT records. The TXT records include the preferred connection, the BSSID (associated), additional TDLS parameters (e.g. supported channel, rates, link identifier, or the like) and P2P parameter. The TXT records contain attributes. In an example, mandatory attributes parameters in the TXT records are: preferconn=td1s/p2p and BSSID=12 bytes (MAC of the AP). In an example, optional attributes parameters in the TXT records are: TDLS parameters (e.g., channelSwitch, channellist, rates, or the like).

For examples of txt records are: /019preferconn=tdls/022bssid=08002700F06D, /019preferconn=tdls/022bssid=08002700F06D (additional TDLS parameters).

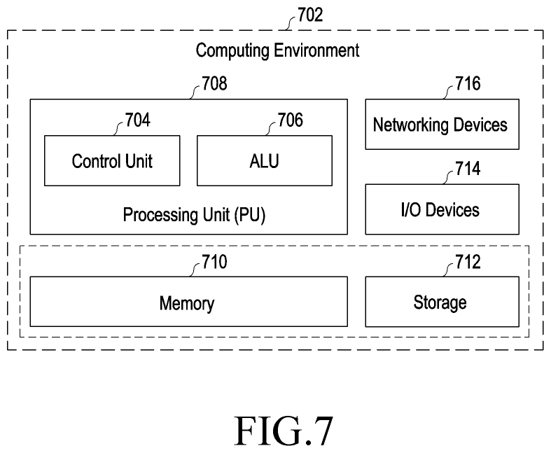

FIG. 7 illustrates a computing environment 702 implementing a mechanism for establishing the P2P service session over the infrastructure link, according to an embodiment as disclosed herein. As depicted, the computing environment 702 comprises at least one processing unit 708 that is equipped with a control unit 704, an Arithmetic Logic Unit (ALU) 706, a memory 710, a storage unit 712, a plurality of networking devices 716 and a plurality Input output (I/O) devices 714. The processing unit 708 is responsible for processing the instructions of the technique. The processing unit 708 receives commands from the control unit 704 in order to perform its processing. Further, any logical and arithmetic operations involved in the execution of the instructions are computed with the help of the ALU 706.

The overall computing environment 702 can be composed of multiple homogeneous or heterogeneous cores, multiple CPUs of different kinds, special media and other accelerators. The processing unit 708 is responsible for processing the instructions of the technique. Further, the plurality of processing units 704 may be located on a single chip or over multiple chips.

The technique comprising of instructions and codes required for the implementation are stored in either the memory unit 710 or the storage 712 or both. At the time of execution, the instructions may be fetched from the corresponding memory 710 or storage 712, and executed by the processing unit 708.

In case of any hardware implementations various networking devices 716 or external I/O devices 714 may be connected to the computing environment 702 to support the implementation through the networking unit and the I/O device unit.

The embodiments disclosed herein can be implemented through at least one software program running on at least one hardware device and performing network management functions to control the elements. The elements shown in FIGS. 1 to 7 include blocks, elements, actions, acts, steps, or the like which can be at least one of a hardware device, or a combination of hardware device and software module.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for establishing a Peer to Peer (P2P) service session over an infrastructure link, the method comprising:
sending, by a source device, an infrastructure discovery request message to discover a wireless service to a sink device;
receiving, by the source device, an infrastructure discovery response message from the sink device;
sending, by the source device, a connection capability exchange request message to discover the wireless service to the sink device;
receiving, by the source device, a connection capability exchange response message comprising a plurality of P2P connection configuration parameters from the sink device; and
establishing, by the source device, a P2P service session with the sink device based on the plurality of P2P connection configuration parameters.

2. The method of claim 1, wherein the P2P connection configuration parameter comprises at least one of a P2P device address, an AutoGo group information, a group identifier, an operating channel information, a device role, an internet protocol (IP) address of the sink device, an IP address of the source device, and a connection capability bitmap.

3. The method of claim 2, wherein the connection capability bitmap indicates support of interfaces by the source device.

4. The method of claim 1, wherein the infrastructure discovery request message and the infrastructure discovery response message are carried over one of a Bonjour protocol, an Universal Plug and Play (UPnP) protocol, IP packets using User Datagram Protocol (UDP), and IP packets using a Transfer Control Protocol (TCP).

5. A method of establishing a peer to peer (P2P) service session over an infrastructure link, the method comprising:
receiving, by a sink device, an infrastructure discovery request message to discover a wireless service from a source device;
sending, by the sink device, an infrastructure discovery response message to the source device;
receiving, by the sink device, a connection capability exchange request message to discover the wireless service from the source device;
sending, by the sink device, a connection capability exchange response message comprising a plurality of P2P connection configuration parameters to the source device; and
establishing, by the sink device, the P2P service session with the source device based on the plurality of P2P connection configuration parameters.

6. The method of claim 5, wherein the P2P connection configuration parameter comprises at least one of a P2P device address, an AutoGo group information, a group identifier, an operating channel information, a device role, an internet protocol (IP) address of the sink device, an IP address of the source device, and a connection capability bitmap.

7. The method of claim 6, wherein the connection capability bitmap indicates support of interfaces by the sink device.

8. The method of claim 5, wherein the infrastructure discovery request message and the infrastructure discovery response message are carried over one of a Bonjour protocol, an Universal Plug and Play (UPnP) protocol, IP packets using an User Datagram Protocol (UDP), and IP packets using a Transfer Control Protocol (TCP).

9. A source device for establishing a peer to peer (P2P) service session with a sink device over an infrastructure link, the source device comprising:
a memory unit; and
a processor unit, coupled to the memory unit, configured to:
send an infrastructure discovery request message to discover a wireless service to a sink device;
receive an infrastructure discovery response message from the sink device;
send a connection capability exchange request message to discover the wireless service to the sink device;
receive a connection capability exchange response message comprising a plurality of P2P connection configuration parameters from the sink device; and
establish the P2P service session with the sink device based on the plurality of P2P connection configuration parameters.

10. The source device of claim 9, wherein the P2P connection configuration parameter comprises at least one of a P2P device address, an AutoGo group information, a group identifier, an operating channel information, a device role, an Internet Protocol (IP) address of the sink device, an IP address of the source device, and a connection capability bitmap.

11. The source device of claim 10, wherein the connection capability bitmap indicates support of interfaces by the source device.

12. The source device of claim 9, wherein the infrastructure discovery request message and the infrastructure discovery response message are carried over one of a Bonjour protocol, an Universal Plug and Play (UPnP) protocol, IP packets using an user datagram protocol (UDP), and IP packets using a transfer control protocol (TCP).

13. A sink device for establishing a peer to peer (P2P) service session over an infrastructure link, the sink device comprising:
a memory unit; and
a processor unit, coupled to the memory unit, configured to:
receive an infrastructure discovery request message to discover a wireless service from a source device;
send an infrastructure discovery response message to the source device;
receive a connection capability exchange request message to discover the wireless service from the source device;
send a connection capability exchange response message comprising a plurality of P2P connection configuration parameters to the source device; and
establish the P2P service session with the source device based on the plurality of P2P connection configuration parameters.

14. The sink device of claim 13, wherein the P2P connection configuration parameter comprises at least one of a P2P device address, an AutoGo group information, a group identifier, an operating channel information, a device role, an Internet Protocol (IP) address of the sink device, an IP address of the source device, and a connection capability bitmap.

15. The sink device of claim 14, wherein the connection capability bitmap indicates support of interfaces by the sink device.

16. The sink device of claim 13, wherein the infrastructure discovery request message and the infrastructure discovery response message are carried over one of a Bonjour protocol, an Universal Plug and Play (UPnP) protocol, IP packets using an User Datagram Protocol (UDP), and IP packets using a Transfer Control Protocol (TCP).

17. A computer program product comprising a computer executable program code recorded on a computer readable non-transitory storage medium, wherein the computer executable program code when executed causing the actions including:
sending, by a source device, an infrastructure discovery request message to discover a wireless service to a sink device;
receiving, by the source device, an infrastructure discovery response message from the sink device;
sending, by the source device, a connection capability exchange request message to discover the wireless service to the sink device;
receiving, by the source device, a connection capability exchange response message comprising a plurality of a Peer to Peer (P2P) connection configuration parameters from the sink device; and
establishing, by the source device, a P2P service session with the sink device based on the plurality of P2P service configuration parameters.

18. A computer program product comprising a computer executable program code recorded on a computer readable non-transitory storage medium, wherein the computer executable program code when executed causing the actions including:
receiving, by a sink device, an infrastructure discovery request message to discover a wireless service from a source device;
sending, by the sink device, an infrastructure discovery response message to the source device;
receiving, by the sink device, a connection capability exchange request message to discover the wireless service from the source device;
sending, by the sink device, a connection capability exchange response message comprising a plurality of Peer to Peer (P2P) connection configuration parameters to the source device; and
establishing, by the sink device, a P2P service session with the source device based on the plurality of P2P service configuration parameters.
